(19) United States
(12) Patent Application Publication
(10) Pub. No.: US 2026/0179167 A1
(43) Pub. Date: Jun. 25, 2026

(54) SYSTEMS AND METHODS FOR EXTENDING SELECTABLE OBJECT CAPABILITY TO A CAPTURED IMAGE USING AN ALTERATION PATTERN

(71) Applicant: Adeia Guides Inc., San Jose, CA (US)

(72) Inventors: Jean-Yves Couleaud, Mission Viejo, CA (US); Tao Chen, Palo Alto, CA (US); Aldis Sipolins, Somerville, MA (US)

(21) Appl. No.: 18/990,746

(22) Filed: Dec. 20, 2024

(51) Int. Cl. G06T 1/00; G06T 7/13; G06V 10/60

(52) U.S. Cl. CPC G06T 1/0071; G06T 7/13; G06V 10/60

(57) ABSTRACT

Systems, methods, apparatuses, and computer-readable media are described herein for capturing an image of a content item, wherein an alteration pattern is applied to a portion of the content item corresponding to an object in the content item. The disclosed techniques may detect, in the captured image, a control watermark applied to at least one portion of the content item, and extract, from the control watermark, embedded metadata indicative of the alteration pattern. The disclosed techniques may, based at least in part on the embedded metadata indicative of the alteration pattern, identify a boundary of a region of the captured image comprising the alteration pattern. The disclosed techniques may cause a portion of the captured image within the identified boundary to be selectable to access, based at least in part on the embedded metadata of the control watermark, supplemental information related to the object.

### BACKGROUND

The present disclosure is directed to systems and methods for enriching supplemental content for, and extending selectable object capability to, a captured image.

### SUMMARY

Modern media distribution systems enable a user to access more media content than ever before, and on more devices than ever before. Media content includes a variety of supplemental content and/or interactive content, related to the media content, that may connect content items within and/or among content distribution platforms to facilitate content access and consumption.

In some approaches, scene metadata for video is generated through a combination of manual annotation, automated algorithms, and artificial intelligence (AI)-driven techniques. For example, metadata is manually added by content creators or editors, who associate scenes with descriptive labels, such as location, time, or key characters and cast. However, as video content production and consumption have scaled dramatically, this manual approach has become inefficient and insufficient to handle large volumes of data. In another approach, automated systems are used to extract metadata by analyzing video content in real time. These systems use techniques such as optical character recognition (OCR) for text, object detection to identify key elements, and scene segmentation algorithms to break down video into discrete sections.

The rise of AI, particularly machine learning (ML) and deep learning models applied to computer vision, has transformed scene metadata generation by adding more granularity and context. AI models are trained to recognize patterns, such as transitions between scenes, facial recognition to identify actors, and audio analysis to detect background sounds or speech. Natural language processing (NLP) models can analyze dialogue and auto-generate tags related to the narrative or themes of a scene. Such metadata can also include emotional tone, key events, or even mood, making videos more searchable and accessible. Additionally, these models allow for the integration of external data sources, which can further enrich scene metadata with relevant contextual information, such as cultural references or historical events. Even though AI continues to advance, and the quality and precision of scene metadata generation improves, the collection of this type of metadata, especially culturally relevant information about scenes, objects or characters featured in a movie or a TV show, is harder to automate and often requires manual curation.

Amazon X-Ray uses metadata to enhance the viewing experience by offering detailed information about scenes, actors, music, and other relevant elements in real time, sourced from a combination of databases like EVIDb, proprietary sources, and machine learning algorithms that analyze the video content to surface insights. For example, when accessing content on Amazon Prime Video, if a user pauses the content, Amazon's X-Ray function provides access to additional information for the content, such as cast information for a current scene of the content. However, if an image or video of the current scene of the media content is captured, such as by a smartphone, this functionality provided by Amazon X-Ray would be lost. That is, while viewing the captured video or image of the Amazon Prime Video content, if the user (or the user's friend with whom the captured content may have been shared) pauses the captured video on his or her smartphone, such pausing action would not trigger the presentation of any additional information (such as cast information) at the smartphone, and the user would not be able to interact with content of the displayed video or image. In such an approach, since capturing an image or video of only the media content eliminates the ability to take advantage of any additional content associated with the media content, such approach lacks the ability to maintain any selectable object functionality (present in an original image or video) in a captured image or video of the media content.

To help address these problems, systems, methods, computer-readable media, and apparatuses are disclosed herein for, e.g., capturing an image of a content item, wherein an alteration pattern is applied to a portion of the content item corresponding to an object in the content item. The disclosed techniques may detect, in the captured image, a control watermark applied to at least one portion of the content item, and extract, from the control watermark, embedded metadata indicative of the applied alteration pattern. Based at least in part on the embedded metadata indicative of the applied alteration pattern, the disclosed techniques may identify a boundary of the region within the captured image, and cause a portion of the captured image within the identified boundary to be selectable to access, based at least in part on the embedded metadata of the control watermark, supplemental information related to the object. The techniques disclosed herein allows the transfer of an object boundary from one display device (e.g., a television) to a capture device (e.g., a smartphone), to enable the capture device to access object metadata based on a user interaction on the capture device.

In addition, to help address these problems, systems, methods, computer readable media, and apparatuses are disclosed herein for a given content item, modifying the content item by: identifying one or more objects in the content item; applying an alteration pattern to a portion of the content item corresponding to an object of the one or more objects in the content item; applying a control watermark to at least one portion of the content item, wherein the control watermark embeds metadata indicative of the applied alteration pattern; and causing, based at least in part on a request, and based at least in part on the applied alteration pattern and the applied control watermark, supplemental information related to the object to be provided to a computing device.

Such aspects utilize digital watermarking technology and alteration patterns to maintain selectable object or item functionality for a captured video or image, even after such image is screen-captured, stored, shared, or printed. By providing a control watermark in the image comprising metadata indicative of the alteration pattern, the disclosed techniques may enable a computing device to determine whether an alteration pattern (and thus supplemental content for an object corresponding to the alteration pattern) exists by detecting the control watermark, and may avoid performing further potentially computationally-intensive processing if such alteration pattern does not exist. As another example, the disclosed techniques may prompt the user to add supplemental content, e.g., via a crowdsourcing method, even if the capture device does not have access to all of the information (e.g., image coordinates) of a device (e.g., a television) playing the content that is the subject of the captured image. In some embodiments, such alteration pattern is indicated in the control watermark, and the disclosed techniques facilitate an efficient technique for accessing supplemental content by detecting the alteration pattern in the captured image or video, and thus identifying boundaries of the desired object, without having to perform image segmentation (e.g., at the client device). In some embodiments, when there is no alteration pattern, a user device and/or computing device which may be accessing the content item may still be permitted to define an object within the captured stream and inform the origin server of the creation of a new object, e.g., for which metadata and/or supplemental content may be associated.

Such control watermark and alteration patterns may be imperceptible to the human eye, thus not interfering with a user's consumption of the content (e.g., being consumed on a first device, such as, for example, a television, when an image of the content is captured using a second device, such as, for example, a smartphone), and the disclosed techniques may be implemented without the need for the first device and the second device to be communicatively connected. In some embodiments, the control watermark may comprise or correspond to a definition of an alteration pattern that can be used to extract the outline of an object regardless of the means of capture or the focus of a capture (e.g., if only part of the object is in the capture frame), and it may not require image segmentation to run on the capture device to extract the boundaries of the object. In some embodiments, the way the object is altered is identified in an invisible watermark that resists capture and compression. For example, the object is modified by selectively altering pixels in a specific way within the boundaries of an object, and encoding steps may be performed to alter the object, and encode the alteration in a watermark. The capture device may decode a control watermark in a captured image of a content item, extract an indication of an alteration pattern and an object identifier from control watermark metadata, use the alteration pattern to detect the portion of the content item having been altered with the alteration pattern, and identify the object corresponding to such detected portion of the content item.

In some embodiments, the capturing is performed by a first computing device while the content item is being displayed on a second computing device, and while the first computing device and the second computing device are not in communication with each other. In some embodiments, a first computing device communicates with a second computing device prior to the capturing, and wherein the capturing, the detecting, and the extracting are performed by the first computing device without further communication with the second computing device.

In some embodiments, the embedded metadata indicative of the applied alteration pattern in the control watermark comprises at least one of a universal resource locator (URL) or an identifier of the object, and the at least one of the URL or the identifier of the object is used to request, over a network, data defining characteristics of the applied alteration pattern for the object, and the data defining characteristics of the applied alteration pattern is used to identify the boundary of the region of the captured image comprising the applied alteration pattern.

In some embodiments, the disclosed techniques further comprise receiving an indication of a selection at a first computing device of a portion of a first image, wherein the selected portion of the first image corresponds to the object of the content item, and causing the computing device to display a prompt to add supplemental content for the object. An indication of the added supplemental content may be received, and the embedded metadata may be updated based at least in part on the added supplemental content. Based on an indication that a selection is received at a second computing device of a portion of a second image, wherein the selected portion of the second image corresponds to the object of the content item, the added supplemental content may be caused to be provided to the second computing device.

In some embodiments, the applied control watermark and the applied alteration pattern are not perceptible to the human eye. In some embodiments, the applied alteration pattern is a watermark.

In some embodiments, the portion of the captured image within the identified boundary is a first portion, the object is a first object, and the disclosed techniques further comprise receiving input in relation to a second portion of the captured image and determining that an alteration pattern is not associated with the second portion of the captured image. The disclosed techniques may further comprise providing a prompt to specify a second object that is present at the second portion of the captured image, and transmitting a reply to the prompt to a remote server, wherein the remote server applies an alteration pattern to a portion of the image corresponding to the second object.

In some embodiments, the captured image is of a frame of a plurality of frames of a video, and wherein the alteration pattern is applied to the portion of the video corresponding to the object by (e.g., for each respective pair of consecutive frames of the plurality of frames) alternating between applying the alteration pattern to a first frame of the pair. and not applying the alteration pattern to a second frame (e.g., of each pair). In some embodiments, the disclosed techniques further comprise identifying the boundary of the region based at least in part by comparing the first frame to the second frame.

In some embodiments, the disclosed techniques further comprise applying the alteration pattern to the portion of the content item corresponding to the object by identifying a plurality of pixels included in the portion of the content item corresponding to the object, and modifying a brightness level of at least a subset of the plurality of pixels.

In some embodiments, the content item is video comprising a plurality of frames, and applying the alteration pattern to the portion of the video corresponding to the object further comprises, for each respective pair of consecutive frames of the plurality of frames, alternating between applying the alteration pattern to a first frame of the video, and not applying the alteration pattern to a second frame of the video. In some embodiments, the computing device detects the alteration pattern based at least in part by comparing the first frame to the second frame.

In some embodiments, the content item is video comprising a plurality of frames, the portion is a first portion of a first frame, and applying the alteration pattern further comprises identifying a second portion of a second frame of the plurality of frames at which the object is present. The disclosed techniques may further comprise, for the first frame, applying the alteration pattern to the first portion, and to a portion of the first frame corresponding to a location of the object in the second portion, and, for the second frame, applying the alteration pattern to the second portion and a portion of the second frame corresponding to a location of the object in the first portion.

In some embodiments, the control watermark is embedded at a portion of the content item that is proximate to, but does not overlap with, the portion of the content item at which the alteration pattern is applied.

In some embodiments, the control watermark is embedded at a portion of the content item that overlaps with the portion of the content item at which the alteration pattern is applied.

In some embodiments, the metadata in the control watermark comprises at least one of a universal resource locator (URL) or an identifier of the object, and the at least one of the URL or the identifier of the object is used to request, over a network, the indication of the alteration pattern for the object.

In some embodiments, the portion of the captured image within the identified boundary is a first portion, the object is a first object, and the disclosed techniques further comprise receiving input in relation to a second portion of the captured image; determining that an alteration pattern is not associated with the second portion of the captured image; providing a prompt to specify a second object that is present at the second portion of the captured image; and based at least in part on the prompt, identifying the second object and applying an alteration pattern to a portion of the image corresponding to the second portion of the captured image.

In some embodiments, the object is included in a plurality of objects of the content item, the method further comprising applying a plurality of alteration patterns to the plurality of objects, respectively, wherein the control watermark comprises metadata indicative of each of the plurality of objects and of each respective alternation pattern.

In some embodiments, the object is included in a plurality of objects of the content item. The disclosed techniques may further comprise applying a plurality of alteration patterns to a plurality of portions of the content item, respectively, wherein the plurality of portions of the content item respectively correspond to the plurality of objects, and applying a plurality of control watermarks to the content item. Each respective control watermark of the plurality of control watermarks may comprise metadata indicative of a particular object of the plurality of objects and an alteration pattern of the plurality of alteration patterns that corresponds to the particular object.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an illustrative system for extending selectable object capability to a captured image of a content item, in accordance with some embodiments of this disclosure.

FIG. 2 shows an illustrative system for enabling supplemental content to be provided for an object, in accordance with some embodiments of this disclosure.

FIG. 3 shows an illustrative process for extending selectable object capability to a captured image of a content item, in accordance with some embodiments of this disclosure.

FIG. 4 shows an illustrative process for extending selectable object capability to a captured image of a content item, in accordance with some embodiments of this disclosure.

FIG. 5 shows an illustrative process for extending selectable object capability into a captured image, in accordance with some embodiments of this disclosure.

FIGS. 6-7 depict illustrative computing devices, systems, servers, and related hardware for extending selectable object capability to a captured image, in accordance with some embodiments of the present disclosure.

### DETAILED DESCRIPTION

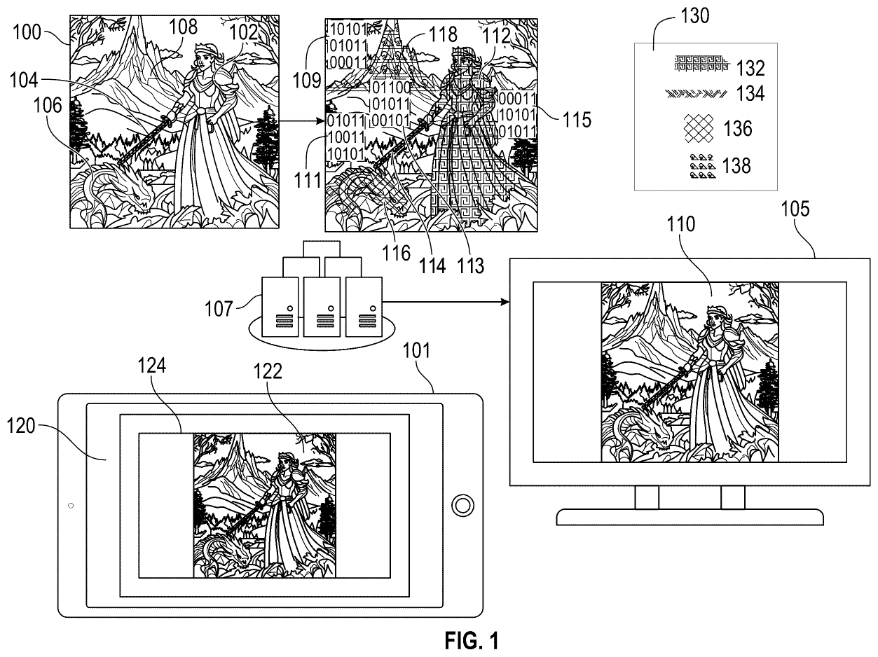

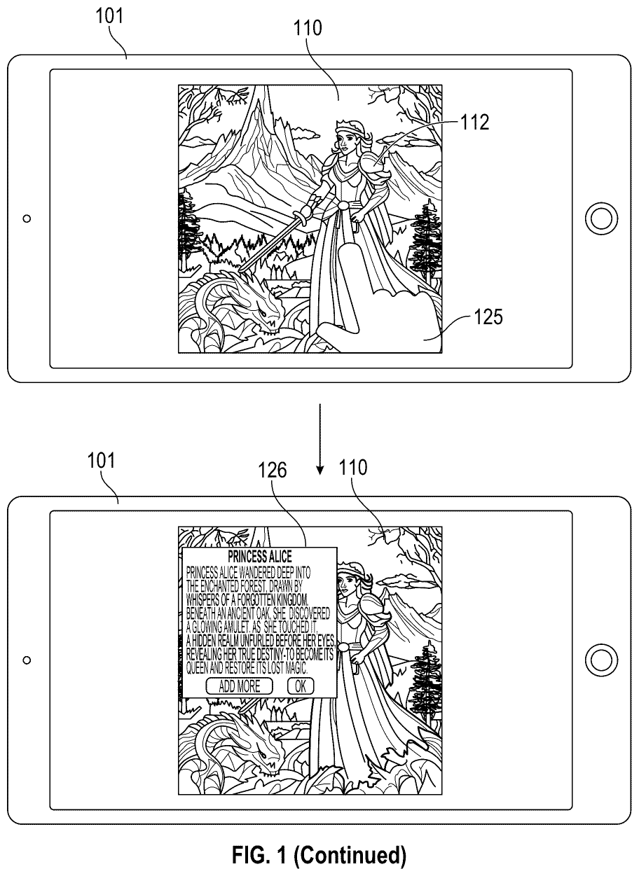

FIG. 1 shows an illustrative system for extending selectable object capability to a captured image of a content item, in accordance with some embodiments of this disclosure. In some embodiments, a media application may be configured to perform the functionalities (or any suitable portion of the functionalities) described herein. The media application may be executed at least in part on computing device 101, computing device 105, and/or at one or more remote servers and/or at or distributed across any of one or more other suitable computing devices, in communication over any suitable type of network (e.g., the Internet). In some embodiments, the media application may be a stand-alone application, or may be incorporated (e.g., as a plugin) as part of any suitable application, e.g., one or more broadcast content provider applications, broadband provider applications, live content provider applications, content provider applications, media asset provider applications, extended reality (XR) applications, e-commerce applications, video or image or electronic communication applications, social networking applications, image or video capturing and/or editing applications, content creation applications, or any other suitable application(s), or any combination thereof.

In some embodiments, the media application may be installed at or otherwise provided to a particular computing device, may be provided via an application programming interface (API), or may be provided as an add-on application to another platform or application. In some embodiments, software tools (e.g., one or more software development kits, or SDKs) may be provided to any suitable party, to enable the party to implement the functionalities described herein.

As referred to herein, the terms “content item,” “media asset,” or “content” may be understood to mean information or data that is consumable or communicable to a user, such as, for example, three-dimensional (3D) content, XR content, television programming, as well as pay-per-view programs, on-demand programs (as in video-on-demand (VOD) systems), live content, Internet content (e.g., streaming content, downloadable content, Webcasts, etc.), video clips, audio, content information, pictures, GIFs, rotating images, documents, playlists, websites, articles, books, billboards or other physical forms or content items or other physical mediums, electronic books, blogs, advertisements, chat sessions, social media, applications, games, and/or any other media or multimedia and/or combination of the same. As referred to herein, the term “multimedia” may be understood to mean content that utilizes at least two different content forms described above, for example, text, audio, images, video, or interactivity content forms. Content may be recorded, played, transmitted to, processed, displayed and/or accessed by a computing device, and/or can be part of a live performance or live event. In some embodiments, the media asset may be generated for display from a broadcast or stream received at a computing device, or from a recording stored in a memory of the computing device and/or a remote server.

XR may be understood as virtual reality (VR), augmented reality (AR) or mixed reality (MR) technologies, or any suitable combination thereof. VR systems may project images to generate a 3D environment to fully immerse (e.g., giving a user a sense of being in an environment) or partially immerse (e.g., giving the user the sense of looking at an environment) users in a 3D, computer-generated environment. Such environment may include objects or items that the user can interact with. AR systems may provide a modified version of reality, such as enhanced or supplemental computer-generated images or information overlaid over real-world objects. MR systems may map interactive virtual objects to the real world, e.g., where virtual objects interact with the real world or the real world is otherwise connected to virtual objects.

Computing device 101 (and/or computing device 105) may comprise or correspond to, for example, a mobile device such as, for example, a smartphone or tablet; a laptop computer; a personal computer; a desktop computer; a display device associated with local/in-premise computing resources and/or cloud computing resources or any other suitable display device; display or monitor and/or thin client; a smart television; a smart watch or wearable device; a camera; smart glasses; a stereoscopic display; a wearable camera; XR glasses; XR goggles; XR head-mounted display (HMD); near-eye display device; a set-top box; a streaming media device; or any other suitable computing device; or any combination thereof. In some embodiments, computing device 101 is equipped with an image capture functionality and/or the ability to capture and analyze a screen shot, whereas computing device 105 may or may not be equipped with such image capture or screenshot functionality, e.g., device 105 may be, in some examples, a “dumb” television, or a billboard.

The media application may generate, access, receive, or otherwise obtain content item 100. In some embodiments, content item 100 may correspond to at least a portion of, or be included in, a media asset. In some embodiments, content item 100 may be a digital image; a photo; a picture; a still image; a live photo; a video; a frames of a video; a movie; a media asset; a recording; a slow motion video; a panorama photo; a GIF, a meme; advertisement; or any other suitable image, or any suitable portion thereof, in any suitable format; or any combination thereof. In some embodiments, content item 100 may comprise one or more frames of a video, e.g., a movie, advertisement, television show, or other media asset, or any other suitable content.

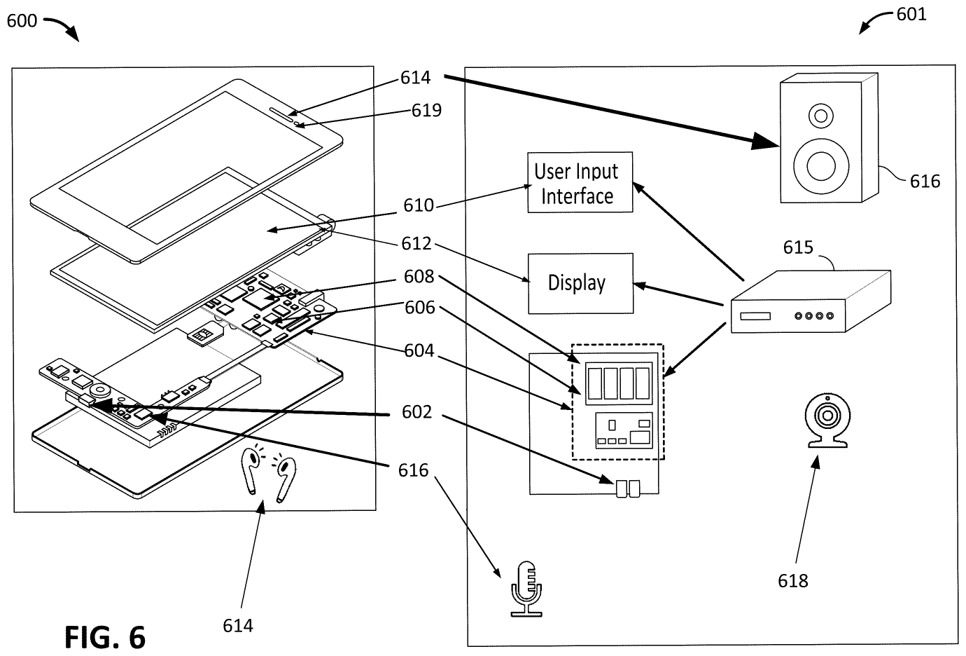

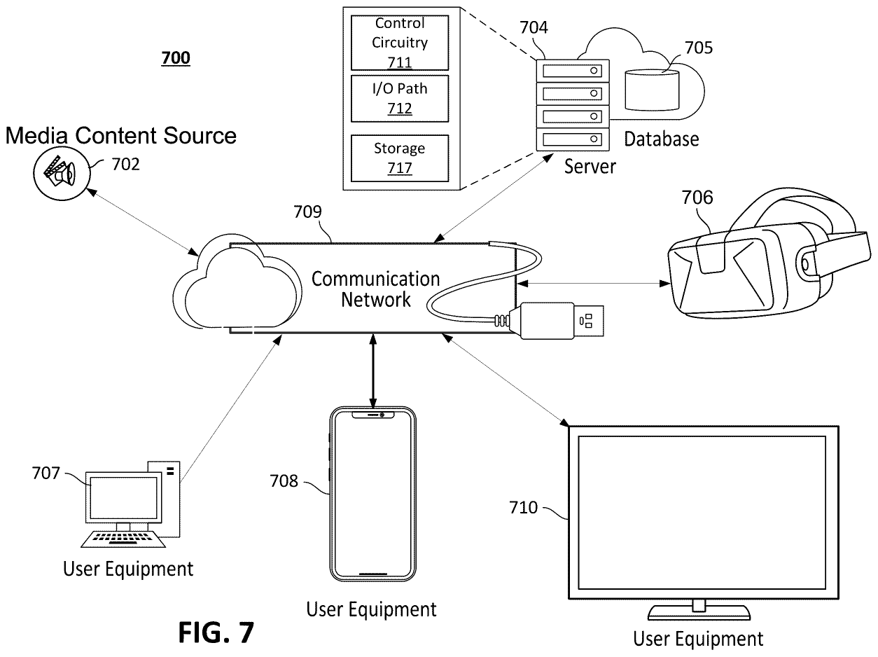

In some embodiments, the media application may access content item 100 over a network (e.g., communication network 709 of FIG. 7 or any other suitable network) from any suitable source (e.g., media content source 702 and/or server 704 of FIG. 7, or any other suitable data source, or any combination thereof). For example content item 100 may be accessed at a server. In some embodiments, the media application may access content item 100 by generating the image data, and/or retrieving content item 100 from memory (e.g., memory or storage 608 of FIG. 6, or storage 717 or database 705 of FIG. 7, or any other suitable data store, or any combination thereof) and/or receiving the image over any suitable data interface, or by accessing content item 100 using any other suitable methodology, or any combination thereof. In some embodiments, the media application may be configured to access, and/or perform processing on, output or transmit, content item 100 in response to receiving a user input or a user request, e.g., to access a website, webpage, or application associated with content item 100, or to access an electronic message (e.g., a text message, email, notification, or any other suitable electronic message, or any combination thereof).

The media application may identify (e.g., at server 107, prior to providing content item 100 to computing device 105 or other client devices) one or more objects in content item 100. As referred to herein, the term “object” may be understood to refer to any person, character, avatar, structure, landmark, landscape, terrain, animal, item, thing, location, place, or any portion or component thereof, any suitable portion of the natural world or an environment, or any other suitable observable entity or attribute thereof visually depicted in a content item (e.g., an image or video). For example, if a content item depicts a sky or skyline, the sky or skyline may correspond to an object, and/or portions thereof (e.g., one or more clouds) may correspond to an object.

In some embodiments, the media application may identify objects 102, 104, 106, and 108 (corresponding to a princess, a sword, a dragon, and a mountain, respectively) using any suitable computer-implemented technique. For example, the media application may identify, localize, distinguish, and/or extract the different objects, and/or different types or classes of the objects, or portions thereof, of content item 100. For example, such techniques may include determining which portions (e.g., groups of pixels) in content item 100 belong to a depiction of princess 102, which portions belong to a depiction of sword 104, and which portions belong to a depiction of dragon 106, and which pixels of content item 100 belong to a background or physical environment surrounding the object(s), or any other suitable portion of content item 100. In some embodiments, the media application may be configured to identify or indicate objects, object classifications, and/or locations of the objects within content item 100, in metadata associated with content item 100 (e.g., embedded in control watermark(s) 109, 111, 113, and 115).

In some embodiments, the media application may identify objects (and other characteristics) via metadata that accompanies content item 100, e.g., the processes disclosed herein may be performed by a client device application, a content provider, a content hosting server, or some other device or application.

Metadata associated with the content item may describe the identified object and/or may be associated with supplemental content 126 (e.g., a URL or other pointer to additional information) related to the identified object. In some embodiments, the metadata may include an identifier of the object, may be associated with alteration patterns applied or to be applied to the object, a playback position within a media stream or other video at which the object appears, coordinates at which the object is depicted in content item 100, and/or may include or reference any other suitable data. In some embodiments, while such coordinate information may be associated with the content item 100, the coordinate information may not be included as part of metadata embedded in the control watermark. In some embodiments, when the media application accesses content item 100, metadata may have been previously associated with content item 100 indicating such object classifications and/or locations of the object within content item 100. The control watermark may be capture-resistant, e.g., may be preserved in a captured image of content item 100.

In some embodiments, as part of identifying a boundary of an object, the media application (e.g., executing at one or more remote servers) may employ machine learning and/or heuristic techniques to identify objects, determine locations (e.g., coordinates within content item 100) of objects, and/or track (e.g., if content item 100 is part of a video) locations of the objects over time. In some embodiments, objects may be identified and localized using, for example: a pixel thresholding technique; an image segmentation technique; a computer vision technique; an image processing technique; object recognition; pattern recognition; an edge detection technique; a color pattern recognition technique; a partial linear filtering technique; regression algorithms; and/or neural network pattern recognition; or any other suitable technique; or any combination thereof. In some embodiments, the image processing system may utilize one or more machine learning models (e.g., naive Bayes algorithm, logistic regression, recurrent neural network, convolutional neural network (CNN), bi-directional long short-term memory recurrent neural network model (LSTM-RNN), or any other suitable model, or any combination thereof) to localize and/or classify objects in a given content item 100, e.g., image or frame of the captured video.

In some embodiments, the media application may generate respective graphical indicators, e.g., bounding shapes, boxes or other bounding mechanisms surrounding a perimeter of and enclosing identified objects 102, 104, 106, and 108; only the four corners of a bounding box or any other suitable portion thereof; a highlighted shape to accentuate or emphasize a target location and/or zoomed-in location; color changes; or any other suitable indication; or any combination thereof. The bounding box may be used, e.g., as server 107, to identify portions of content item 100 to which the control watermark and/or alternation patterns are to be applied, though such bounding box may not be transmitted to or visible to users of computing device 105. The bounding shape may be any suitable shape (e.g., a circle, a box, a square, a rectangle, a polygon, an ellipse, or any other suitable shape, or any combination thereof). The bounding shape may be calculated in any suitable manner, and may be fitted to particular objects and/or portions of an image using any suitable technique, and other portions of the image may be excluded from the bounding shape. In some embodiments, the depictions of objects 102, 104, 106, and 108 may be surrounded by bounding boxes. Such bounding boxes may or may not be present in content item 100 when content item 100 is stored or transmitted. For example, when transmitted from server 107, content item 100 may be transmitted without the bounding boxes, but content item 100 may be stored at server 107 with the bounding boxers.

In some embodiments, the media application (e.g., executing at server 107) may modify content item 100, to embed one or more control watermarks 109, 111, 113, and 115 (e.g., made not visible to the human eye using one or more stenographic techniques) in content item 100 (e.g., a video frame) that are associated with one or more objects in a scene. In some embodiments, the control watermark may be invisible to the human eye such as when embedded using steganography or may be visible such as when embedded using QR codes or the like. The media application may alter the one or more objects in the scene in a manner that is defined at least in part in the one or more control watermarks 109, 111, 113, and 115 to help in their detection (e.g., at computing device 101). In some embodiments, such modification of content item 100 may provide a way for user device to detect a request for metadata addition (e.g., user-generated metadata input), and/or a request to access supplemental content related to an object, in a captured image of a content item 100 shown on a computing device 105 (e.g., a TV) through a computing device 101 (e.g., a smartphone or AR glasses) without the need for the devices to be communicatively connected. In some embodiments, the computing devices 101 and 105 may be in communication (e.g., via Wi-Fi, Bluetooth, or any other suitable connection), such that, for example, computing device 101 operates as a remote control for computing device 105, but the capturing of an image of content item 100 and subsequent processing of the captured image by computing device 101 to access supplemental content via the captured image, may not rely on such communication with computing device 105, e.g., without further communication being required. In some embodiments, computing device 105 may, for example, lack touchscreen capability, and a user in a vicinity of computing device 105 may use computing device 101 to capture an image of content item 100 being displayed at computing device 105, where the techniques described herein may enable supplemental content to be accessible via a touchscreen of computing device 101 via a captured image of the content item.

In some embodiments, as part of a content encoding workflow, a media platform (e.g., server 107) may identify one or more objects in its video programs and extract their boundary information using one or more of the techniques described in U.S. application Ser. No. 18/141,059 filed Apr. 28, 2024 and published as U.S. Patent Application No. 2024/0364970 A1 in the name of Adeia Guides Inc., the contents of which are hereby incorporated by reference herein in their entirety. In some embodiments, the process may be, at least in part, automated, where a first module performs image segmentation on a video frame and another module tracks objects from frame to frame using one or more of the techniques described, for instance, in Ho Kei Cheng and Alexander G. Schwing. “XMem: Long-Term Video Object Segmentation with an Atkinson-Shiffrin Memory Model”. In ECCV, 2022, the contents of which are hereby incorporated by reference herein in their entirety. In some embodiments, the process may be, at least in part, manual where a reviewer indicates boundaries of objects to be identified.

In some embodiments, using the information of the identified object boundaries, the media application may apply an alteration pattern to the portion(s) (e.g., pixels) enclosed in the extracted boundary. For example, to modify content item 100, the media application may apply alteration pattern 132 within the identified boundaries of object 102 to obtain modified object 112; may apply alteration pattern 134 within the identified boundaries of object 104 to obtain modified object 114; may apply alteration pattern 136 within the identified boundaries of object 106 to obtain modified object 116; and/or may apply alteration pattern 138 within the identified boundaries of object 108, to obtain modified object 118. In some embodiments, each of alteration patterns 132, 134, 136, and 138 may be distinct patterns from one other. In some embodiments, one or more of the alteration patterns may be a QR code, a bar code, or another suitable type of pattern. In some embodiments, a boundary itself of an object may, at least in part, constitute an alteration pattern. In some embodiments, alternation patterns 132, 134, 136, and 138 may be selected from a database or datastore 130 of alteration patterns, at server 107 or accessible by server 107.

In some embodiments, one or more of alteration patterns 132, 134, 136, and 138 may comprise any suitable number of pixels and may repeat themselves within the boundaries of their corresponding content item video object. In some embodiments, the media application may apply one or more of alteration patterns 132, 134, 136, and 138 to each frame of the video program in which its corresponding object appears, or in only a subset of the frames in which the object is present. In some embodiments, the media application may obtain modified objects 112, 114, 116, and 118 by applying one or more of alteration patterns 132, 134, 136, and 138 by altering a brightness level of one or more pixels within respective boundaries of a corresponding object 102, 104, 106, and 108. For example, if the alteration is a “checkerboard” pattern, as shown in alteration pattern 116, then the pixels in the “white” cells may have their brightness unchanged while the pixels in the “black” cells may have their brightness modified, with each checker cell a certain width and height (e.g., 20 pixels). Depending on the level of increase, the alteration may not be perceivable by a human eye but may be detected by a machine knowing which pattern to look for.

If pixels are in an RGB space, and if R, G, and B are the respective coordinates of a pixel in the red, green and blue channel or component, in a non-limiting example, to modify an image using an alteration pattern, the media application may derive an estimated luminance L with the formula (1):

$$L = 0.2126 \cdot R + 0.7152 \cdot G + 0.0722 \cdot B \qquad ( 1 )$$

To increase (or decrease) the luminance by a value ΔL, in a non-limiting example to modify an image using an alteration pattern, the media application may use the following formula:

$$With {L}_{new} = L + Δ L \qquad ( 2 )$$

$${R}^{′} - R \cdot \frac{{L}_{new}}{L} \cdot {G}^{′} - G \cdot \frac{{L}_{new}}{L} \cdot {B}^{′} - B \cdot \frac{{L}_{new}}{L} \qquad ( 3 )$$

If pixels are in a YUV space, Y is directly the luminance, in a non-limiting example to modify an image using an alteration pattern, increasing or decreasing Y by ΔL may be performed (ignoring the clamping) by:

$$Y ’ = Y + Δ L \qquad ( 4 )$$

In some embodiments, in order to increase the likelihood of detection of the alteration pattern and the associated covered area by a capture device, the media application may alternate frames with and frames without alteration. For example, a capture device (e.g., computing device 101) may then be able to detect an alteration pattern and extract the associated area by, for instance (e.g., in the case when a luminance alteration algorithm is used), subtracting the luminance information of the frame with an alteration pattern from the frame, while adjusting for potential pixel motion. The resulting image representation can then be sent to a pattern detection module. The content alteration workflow may also take into account the way the final media is encoded, so that the prediction information from one frame to another may be used to account for the object motion when subtracting frames without alteration from frames with alteration.

The alteration pattern being applied in the luminance space is one technique that may be employed, but any other suitable technique may be employed to apply the alteration pattern. As another example, colors of an object may be altered as part of applying the alteration pattern, and such alteration may be detected by the capture device.

In some embodiments, the alteration pattern may be omitted from the first frame at a scene change, allowing a clean, high-quality reference frame (e.g., a reference frame at the scene change may be encoded at a relative quality for use in prediction in encoding the following frames) for further scene comparison during detection. In some embodiments, the content alteration workflow may account for the movement of an object within a frame and select an alteration area that coincides with the location of the object at all frames in which the object is present (hence expanding the object area for each individual frame). In another example, the alteration workflow may select an alteration area within each frame in which an object is present that represents the intersection of all the areas in each frame in which an object is present (hence reducing the alteration area for each frame). These two methods allow for a stable frame-to-frame alteration location, hence helping in the detection of the altered area during capture. In another instance, the alteration workflow may select one of these two alteration methods depending on the object motion amplitude.

As shown in FIG. 1, in some embodiments, if multiple objects are present and are to be encoded in a frame, multiple patterns 132, 134, 136, and 138 may be generated and applied to the pixels within the boundaries of each respective object 102, 104, 106, and 108.

In addition to the modification of content item 100 to include one or more of alteration patterns 132, 134, 136, and 138 to obtain a modified content item 110 comprising modified objects 112, 114, 116, and 118, the media application may further modify content item 100 to add control watermarks 109, 111, 113, and 115 indicating the presence of an alteration. Such control watermarks may, for example, embed and/or encode metadata in content item 100. For example, the media application may use any suitable algorithm or technique to provide and apply digital control watermarks 109, 111, 113, and 115 as markers to embed metadata into noise-tolerant signals such as, for example, visual (e.g., image or video) data, text data and/or audio data of content item 100. In some embodiments, this may be understood as caching data (e.g., metadata and/or supplemental content) in content item 100. In some embodiments, a digital watermark may be invisible or imperceptible to the user such that the watermark data is hidden in content item 100 but nonetheless available for subsequent extraction and/or processing. Alternatively, the watermark may be visible, such that when content item 100 is accessed or played back, the watermark data is displayed on screen, e.g., in an unobtrusive manner. While applying a digital watermark is discussed in the example of FIG. 1, in some embodiments, the media application may employ any suitable steganography technique or cryptography technique, or any other suitable computer-implemented technique, to embed and/or encode metadata in content item 100, additionally or alternatively to applying a digital watermark. In some embodiments, control watermarks 109, 111, 113, and/or 115 may be embedded using, for example, one or more of the techniques described in A. Melman, O. Evsutin and D. Smirnov, “An Image Watermarking Algorithm in DCT Domain Based on Optimal Patterns,” 2023 XVIII International Symposium Problems of Redundancy in Information and Control Systems, Moscow, Russian Federation, 2023, pp. 1-5, the contents of which are hereby incorporated by reference herein in their entirety.

In some embodiments, control watermarks 109, 111, 113, and 115 may be embedded in the content item 100 prior to altering the original frame with alteration patterns 132, 134, 136, and/or 138, or after altering the original frame with alteration patterns 132, 134, 136, and/or 138. If inserted prior to altering the original frame, the watermarking algorithm may be selected based at least in part on being resistant to luminance alteration or to any scheme used to alter the original frame. In some embodiments, control watermarks 109, 111, 113, and 115 may be inserted in frames that are not altered but where a marked object is present if frames containing the marked object are not all altered.

In some embodiments, control watermarks 109, 111, 113, and 115 may be inserted at a location in the frame that coincides with (or is otherwise proximate to) the location of the marked object. For example, control watermark 109 (e.g., embedding an indication related to alteration pattern 138 of modified object 118) may be embedded inside the boundaries of or otherwise proximate to modified object 118; control watermark 111 (e.g., embedding an indication related to alteration pattern 136 of modified object 116) may be embedded inside the boundaries of or otherwise proximate to modified object 116; control watermark 113 (e.g., embedding an indication related to alteration pattern 134 of modified object 114) may be embedded inside the boundaries of or otherwise proximate to modified object 114; and control watermark 115 (e.g., embedding an indication related to alteration pattern 132 of modified object 112) may be embedded inside the boundaries of or otherwise proximate to object 112.

In some embodiments, each of control watermarks 109, 111, 113, and 115 may embed the same information (e.g., indications of each alteration pattern in the modified content item 110) or different information (e.g., only an indication for an alteration pattern for an object proximate to the control watermark). In some embodiments, each control watermark may be associated with a particular object, or multiple objects, of content item 100, and/or may be applied to an entirety of content item 100, or any suitable portion(s) thereof. For example, the media application may reference the locations (e.g., pixels or coordinates) of each object identified, e.g., by server 107, and may embed respective control watermarks for each object at the location in content item 100 corresponding to the depiction of the corresponding object.

In some embodiments, if the media application determines there are not enough pixels to insert the watermark within the boundaries of an object, such as the sword 104 in FIG. 1, the control watermark 113 may be inserted in a location close by (e.g., within a threshold pixel distance from object 104). In some embodiments, to provide redundancy, more than one control watermark may be inserted for an object (e.g., replicated at various portions of content item 100), or the location of a control watermark within the boundary of an object (or in close proximity of an object) may vary to account for the various points of focus a capture device (e.g., computing device 101) may have.

In some embodiments, the control watermarks 109, 111, 113, and 115 may include information about whether or not an alteration pattern has been applied to content item 100 (e.g., a frame) the control watermark is present in, to help a capture device with the detection of an alteration pattern. In some embodiments, the media application may alternate frames with a control watermark and an alteration pattern, frames without a control watermark and an alteration pattern, frames without a control watermark but no alteration pattern and frames with neither a control watermark nor an alteration pattern, to help facilitate the detection of the alteration pattern during playback and capture.

In some embodiments, the control watermarks 109, 111, 113, and 115 may include a data payload of metadata comprising a base URL and/or an object identifier (ID) for supplemental metadata retrieval, and/or any other suitable data (e.g., an indicator if the control watermark is within the boundaries of the object it controls) may be appended within the payload of the control watermark. The supplemental metadata retrieved via the base URL and/or object ID may include the alteration pattern definition (e.g., checkerboard, a size or shape or other data for portions of the alteration pattern to assist in detection, and/or any other suitable indication of an alteration pattern) and/or other data (e.g., calibration information, such as, for example, the original aspect ratio of the video). Such information may be used by a client device (e.g., computing device 101) detecting the alteration pattern. In some embodiments, the embedded metadata may include supplemental content related to a given object in the modified content item. The supplemental content may include, for example, a URL, an advertisement, additional information or background related to an object, instructions to launch an application associated with the object (e.g., a virtual try-on application, a video game or gaming application, a streaming service application, a content sharing application, etc.) option(s) to purchase a product(s) corresponding to or otherwise related to the object, and/or other suitable descriptions or information related to a one or more objects in content item 100, or any suitable combination thereof.

As shown in FIG. 1, modified version 110 of content item 100, as modified with control watermark(s) 109, 111, 113, and 115 and alteration pattern(s) 132, 134, 136, and 138, may be provided to and displayed at computing device 105, e.g., via server 107 and a content delivery network (CDN). For example, a content provider associated with server 107 may edit a video program to include one or more frames with control watermarks and alteration patterns. In some embodiments, the media application may capture an image or video of a real-world environment external to computing device 101 to obtain captured image 120, or perform a screen capture. In some embodiments, captured image 120 may correspond to a copy of modified content item 110 printed on a traditional roadside billboard, paper, or a poster, or otherwise printed to exist in physical form in any other suitable manner. In some embodiments, captured image 120 may correspond to a direct screen capture, e.g., received via an electronic message and/or via the Internet.

In some embodiments, computing device 101 may capture an image and/or video 120 of the content item 100 being displayed at computing device 101. For example, a user may be holding or using computing device 101 while in a vicinity of computing device 105. In some embodiments, the media application may be used to capture the image or video of content item 100 shown on computing device 105, and detect such markings in a video program. Upon detection of a control watermark, the media application may retrieve the data payload (e.g., URL and/or object ID) and download the definition of the alteration pattern associated with the object ID.

In some circumstances, the coordinate system of image 120 captured by computing device 101 may differ from the coordinate system of computing device 105 displaying content item 100. For example, image 120 captured by computing device 101 may be distorted (e.g., cropped, inverted or geometrically altered) in a manner that renders ineffective the inclusion of geometric information in the control watermark. In some embodiments, computing device 101 may crop captured image 120 to isolate the content (e.g., portion 122 of image 120 comprising the objects and background of the content item) from other portions of image 120 (e.g., portion 124 of computing device 101 captured in image 120, at which portions of content item 100 are not displayed). In some embodiments, the boundaries of the selected object may be highlighted or otherwise emphasized. In some embodiments, computing device 101 may adjust the geometry of the cropped image such that the cropped image is projected into a rectangular plane, and may then convert the resulting image into a space related to the alteration method. For instance, in case of a brightness adjustment alteration, the media application (e.g., executing at least in part on computing device 101) may convert the image into a luminance space using the formulas (1), (2), (3) and/or (4) listed above, and/or using any other suitable technique(s). The media application may then proceed to compute a correlation factor between the downloaded pattern and the luminance image, using any suitable technique, such as, for example, one or more of the techniques for rotation and scale invariant template matching described in Bolin Liu and Xiao Shu and Xiaolin Wu, “Fast Screening Algorithm for Rotation and Scale Invariant Template Matching,” 2017, arXiv:1707.05647v2, the contents of which are hereby incorporated by reference herein in their entirety. In some embodiments, the functionalities of the media application may be supported natively, e.g., as part of an operating system of a computing device, or as a third-party application.

In some embodiments, if the media application also has the information that the control watermark was located within the boundary of an object, such information may be used to accelerate the pattern-matching algorithm. In case there are alternating frames with and without alteration patterns, the media application may perform denoising in relation to the difference between frames with alteration patterns and frames without. For example, the media application may compute an average over multiple frames by performing a comparison of, for example, three frames with a pattern versus three frames without the pattern. For example, subtraction with every other frame results in a difference in motion, while subtraction with the next frame exhibits the pattern along with motion, to help determine which frame(s) contain the alteration pattern.

In some embodiments, the media application, having extracted each of the alteration patterns in the luminance space and having obtained the boundary information for the object in the coordinate space in relation to computing device 101, may enable an interaction 125 within the boundaries of an object (e.g., identifiable by way of the corresponding alteration pattern) in captured image 120 to be associated with the object (e.g., princess object 112 in in modified content item 110) so that the viewer can access supplemental content, as shown at 126 of FIG. 1.

Supplemental content 126 may, for example, provide additional information regarding a background story or other information related to princess 102, e.g., in relation to a plot of content item 100, or otherwise. Interaction 125 may be, for example, a touchscreen input, a keyboard input, a mouse input, a voice input, a biometric input, or any other suitable input, or any suitable combination thereof. In some embodiments, supplemental content 126 may be provided as an overlay on captured image 120 displayed at computing device 101, or otherwise displayed simultaneously with captured image 120, or a user of computing device 101 may be redirected to a new application or website to access the supplemental content and/or instead of content item 100 such as, for example, via a web browser, or using any other suitable display arrangement).

In some embodiments, the media application may use a classification of a particular object and/or an identifier of a particular object to identify and/or retrieve relevant supplemental content 126, e.g., based on a web crawl, based on data stored at any suitable database, based on data from any suitable application, based on trending or popular data, based on locally stored data, based on a user profile of a user, or based on any other suitable data, or any combination thereof. In some embodiments, upon receiving selection of a particular object, the supplemental information may be directly accessed, and/or the user may be presented various options of supplemental information he or she can further select and access. In some embodiments, the information may be presented in the form of an email, SMS message, MMS message, notification, popup, overlay, or any other suitable method for displaying information, and/or may be provided at a second screen computing device. In some embodiments, the supplemental content 126 for a particular object may be updated each time a user selects the particular object, or such supplemental content 126 may be updated continuously or periodically, independent of a user selection of the particular object. In some embodiments, the supplemental content may be interactive content and/or the supplemental content may be used for e-commerce purposes, e.g., providing a user with the ability to purchase a product or service related to an object for which the supplemental content is provided.

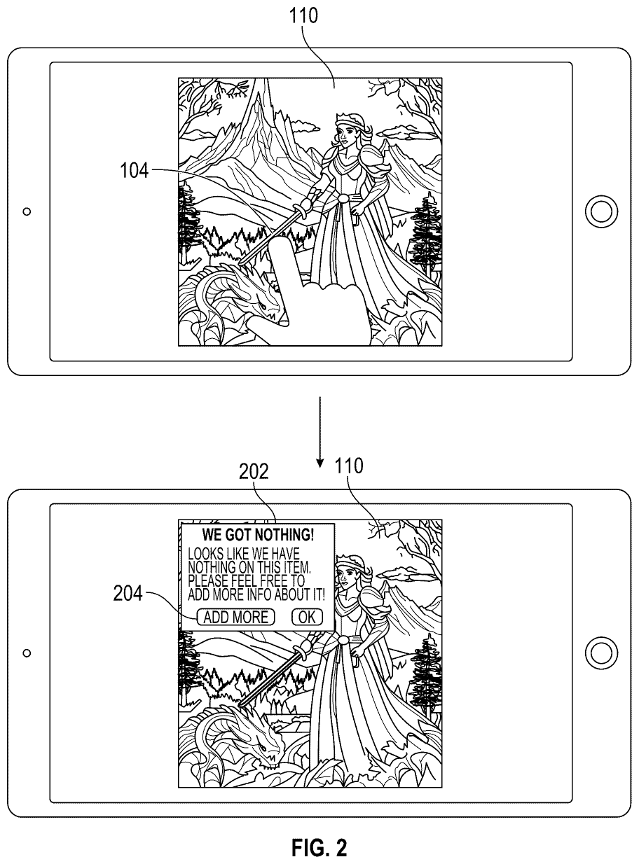

As shown in FIG. 2, if an object (e.g., sword 104) is identified and/or selected, but the media application determines that no supplemental content is available for that object, the media application may prompt 202 for the user to enter their own information, e.g., by selecting option 204, to provide a URL and/or any other suitable data for consumption by subsequent users that access content item 100. For example, the media application may cause information received from the user by way of selecting option 204 to be transmitted to, e.g., server 107, and associated with or included as metadata for the particular frame of content item 100. In some embodiments, the supplemental information may be provided via server 107 or via an associated database. In some embodiments, the supplemental content may be used to, e.g., update the embedded metadata and/or communicate the supplemental content and/or updated metadata to a server (e.g., server 107) associated with a content provider.

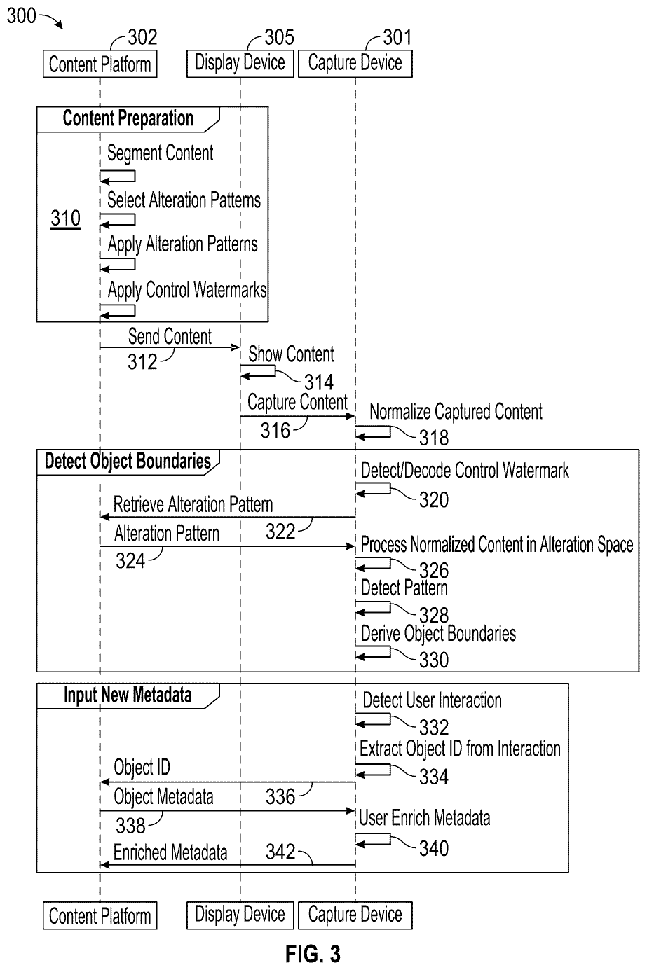

FIG. 3 shows an illustrative process 300 for extending selectable object capability to a captured image of a content item, in accordance with some embodiments of this disclosure. At 310, content platform 302 (e.g., server 107 of FIG. 1) may perform content preparation, including segmenting a content item 100 to identify one or more objects 102, 104, 106, and/or 108, selecting an alteration pattern 132, 134, 136, and 138 for one or more of such objects, applying the alteration pattern(s) 132, 134, 136, and 138 with respective boundaries of the objects, and applying control watermarks 109, 111, 113, and/or 115 (e.g., proximate to a location of the respective objects). In some embodiments, one or more of the alteration patterns may be implemented as a watermark.

Any suitable watermarking technique or algorithm may be employed to apply the control watermarks and/or the alteration patterns. Based on the particular watermarking technique or algorithm that is employed, robustness to attacks, the amount or capacity of watermarked data capable of being carried, and/or the quality (e.g., imperceptibility) of watermarked image may vary. In some embodiments, the digital watermark may comprise data that identifies ownership of the copyright of content item 100 and/or may comprise data that can be used in forensic tracing on images and videos (e.g., identifying a source or consumer or a client device's information or account or profile information). Such digital watermark may be used to embed metadata that is not visible to the viewer in the video or image data. In some embodiments, the digital watermark may be used in conjunction with checksum or error-correction code techniques, in embedding metadata in content item 100. In some embodiments, such if the content item is a part of a video, a watermark may be embedded across various frames or segments of the video. In some embodiments, different image frames to which watermarks have been applied may be combined, such as with unwatermarked image frames, to create a video content item.

In some embodiments, a watermark may be applied to (e.g., superimposed on) a one or more blocks of pixels of content item 100, or to content item 100 as a whole, in the spatial domain or the frequency domain. In some embodiments, control watermarks embedding metadata and/or supplemental information associated with a particular object of the plurality of objects in content item 100 may be applied at locations within content item 100 corresponding to locations of the particular respective object. In some embodiments, superimposing a control watermark on the digital pixel block may comprise adding or subtracting watermark pixel values to or from the digital pixel values of content item 100. In some embodiments, the same or different watermarking techniques or algorithms may be applied at various portions of content item 100. In some embodiments, a watermark for a particular object may be applied at multiple portions of content item 100, in case one or more of such portions are cropped out when a captured image is acquired. In some embodiments, a control watermark or alteration pattern may be stored for later comparison with watermarks identified in subsequently analyzed images.

In some embodiments, an image or pixel block may be transformed into the frequency domain by the application of a transform, such as the discrete cosine transform, and the frequency domain may allow very detailed (high-frequency) information in the pixel block to be separated from very gradual or undetailed (low-frequency) information. For example, in the frequency domain, the watermark may be applied as adjustments to high frequency areas, and which may be less likely to be altered by subsequent alteration or encoding of the pixel block. In some embodiments, in the spatial domain a pixel may be associated with coefficients for different base colors (e.g., red, blue, and green color components), and to maintain color neutrality, the addition or subtraction of the watermark may be performed for each of the color coefficients, to embed hidden information in content item 100.

In some embodiments, the control watermark may introduce various types of variation to encode information. For instance, a watermark image may introduce sinusoidal variance in image properties that may include, but are not limited to, hue, saturation, brightness, color value, luminance, or contrast. The sinusoidal variance may be applied via a gradient that changes intensity with the wave pattern. In some embodiments, the control watermark may introduce various types of visual, audio and/or text patterns to encode information, e.g., where different patterns can correspond to different bit strings “10,” “11,” “00,” and “01,” and data included in the control watermark may comprise a series of such bit strings (e.g., as shown at 109, 111, 113, and 115 of FIG. 1). In some embodiments, the watermark may be encoded in various image properties, e.g., waves having different amplitudes and/or frequencies may represent different bit values. In some embodiments, the shapes or patterns used to encode information in a watermark may be determined based on factors that may include, but are not limited to: the visibility of different patterns to the human eye, the detectability and/or removability of different patterns by computer algorithms, and the type of image (e.g., the frequency) to which the watermark is being applied.

In some embodiments, the control watermark(s) applied at 310 may comprise the definition of an alteration pattern that can be used to extract the exact outline of an object regardless of the means of capture or the focus of a capture (e.g., if only part of the object is in the capture frame). In some embodiments, such techniques enable image segmentation not to be required to run on the capture device (e.g., computing device 101) to extract the exact boundaries of the object. In some embodiments, such techniques embed multiple patterns in multiple bounded areas for the sake of detecting said bounded areas after image recapture, and provide a process to associate user-generated metadata to an object “lifted” from a video.

At 312, the media application may transmit the content item as modified at 310 (e.g., modified content item 110 of FIG. 1) to display device 305 (e.g., computing device 105 of FIG. 1), and, at 314, display device 305 may display such content item. At 316, capture device 301 (e.g., computing device 101 of FIG. 1) may capture an image of the content item being displayed on display device 305. At 318, capture device 301 may normalized the captured image of the content item. For example, as discussed above, the coordinate system of image 120 captured by computing device 101 may differ from the coordinate system of computing device 105 displaying content item 100. For example, image 120 captured by computing device 101 may be distorted, cropped, inverted or geometrically altered in a manner that renders ineffective the inclusion of geometric information in the control watermark. In some embodiments, computing device 101 may crop captured image 120 to isolate the content (e.g., portion 122 of image 120 comprising the objects and background of the content item) from other portions of image 120, e.g., portion 125 of computing device 101 captured in image 120, at which portions of content item 100 are not displayed). In some embodiments, computing device 101 may adjust the geometry of the cropped image such that the cropped image is projected into a rectangular plane, and may then convert the resulting image into a space related to the alteration method. For instance, in case of a brightness adjustment alteration, the media application (e.g., executing at least in part on computing device 101) may convert the image into a luminance space using the formulas (1), (2), (3) and/or (4) listed above, and/or using any other suitable technique(s). The media application may then proceed to compute a correlation factor between the downloaded pattern and the luminance image, using any suitable technique.

In some embodiments, one or more of steps 320-330 may be performed to detect object boundaries within the captured image of the content item. At 320, capture device 301 may detect or decode the control watermark(s) embedded in modified content item 110, and based on metadata associated with the embedding, retrieve a definition of the alteration pattern from content platform 302, at 322. For example, a URL may point to the definition, which can include a bitmap representation of the alteration pattern, an image in base64 or a JSON structure that include a base64 encoding of the bitmap, or the like, or any combination thereof, allowing for a representation of the alteration pattern. At 324, content platform 302 may transmit the definition of the alteration pattern to capture device 301, and, at 326, capture device 301 may process normalized content in the alteration space based at least in part on the received alteration pattern definition (e.g., checkerboard pattern 136, such as shown at modified dragon object 116 of FIG. 1), to (at 328) detect such pattern. Based at least in part on detecting such pattern, capture device 301 may derive the object boundaries, at 330. Based on receiving input at capture device 301 within such boundaries, supplemental content related to an object associated with the boundaries may be provided (e.g., supplemental content 126 or other interactive element or user interface that allows supplemental content to be identified, accessed, or retrieved).

In some embodiments, one or more of steps 332-342 may be performed to enable new metadata to be input for an object in the captured image of the content item. At 332, capture device 301 may detect a user interaction, e.g., within the boundaries of an object, at a region where an alteration pattern is present (e.g., capable of being detected by a computer, but not visible to a user). At 334, based on the detected user interaction, capture device 301 may extract an object identifier, and may transmit (at 336) the object identifier over a network to content platform 302. At 338, upon receiving the object metadata, content platform 302 may retrieve object metadata corresponding to the object, and transmit such metadata (e.g., a URL or other supplemental information) to capture device 301. In some embodiments, a user of capture device 301 may be prompted, at 340, to enrich the metadata for one or more of the objects in the captured image of the content item, and such enriched metadata may be provided, at 342, to content platform 302, to enable the enriched metadata to be stored and provided for subsequent instances of accessing supplemental information associated with content item 110, e.g., by way of captured images of content item 110.

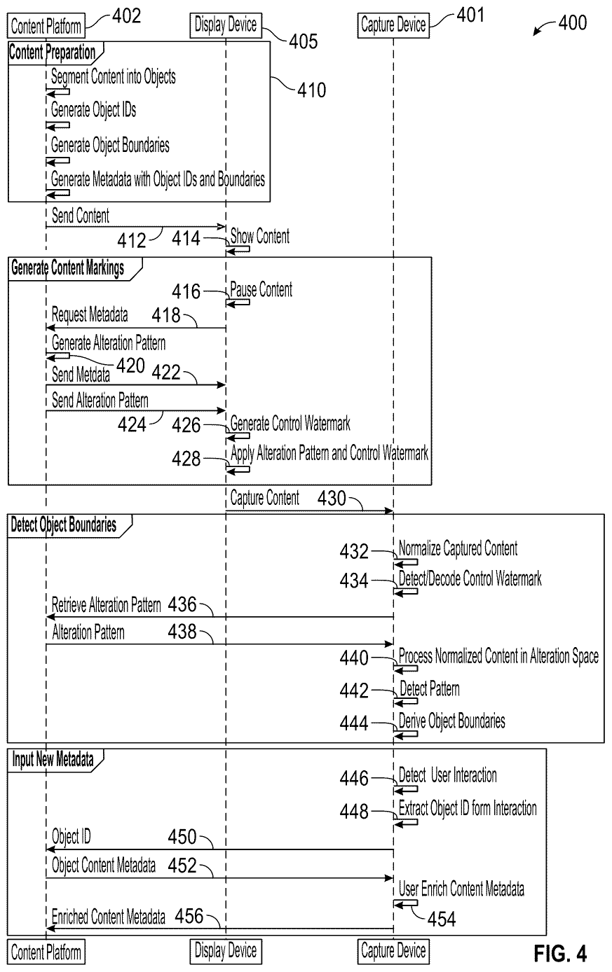

FIG. 4 shows an illustrative process 400 for extending selectable object capability to a captured image of a content item, in accordance with some embodiments of this disclosure. In the example of FIG. 4, watermarking and content alteration may be performed at or for display device 405. At 410, content platform 402 (e.g., server 107 of FIG. 1) may perform content preparation, including segmenting a content item 100 to identify one or more objects 102, 104, 106, and/or 108, generating object IDs for such segmented objects, generating object boundaries (e.g., using a bounding box) for such segmented objects, and generating metadata comprising the object IDs and boundaries. At 412, content platform 402 may send, to display device 405 (e.g., over a network, the content item as prepared/processed at 410, and at 414, display device 405 may display the content item,

At 416, display device 405 may pause the content item being displayed on display device 405, e.g., based on input received from a user. In some embodiments, display device 405 (e.g., a TV or any other device displaying the content) may receive alteration instructions from the content platform 402, instead of the alteration being directly embedded into content item 100 (e.g., included in a video stream), and display device 405 may alter the content as instructed by content platform 402 on the fly. In one example, the alteration of the content by display device 405 may be triggered by a user action such as, for example, a pause request. For instance, upon receiving an instruction to pause a program, a streaming service (e.g., included as part of the media application or being in communication with the media application) may display a message indicating that objects in the video are eligible or otherwise associated with metadata. Since display device 405 now only produces one frozen frame, display device 405 may generate control watermarks and alteration patterns locally and insert them on a time basis: the display device may generate an image with and without the alteration patterns present and display one and the other during one or more two-second periods. This facilitates the decoding on the capture device side as no motion artifact is generated.

For example, at 418, display device 405 may, based at least in part on the pause command, request metadata (e.g., associated with one or more objects displayed in the content item) from content platform 402. At 420, content platform 402 may generate one or more alteration patterns (e.g., checkerboard pattern 136, such as shown at modified dragon object 116 of FIG. 1) for one or more objects in the content item (e.g., at the pause location). At 422 and 424, content platform 402 may transmit metadata, e.g., defining or otherwise indicative of the one or more alteration patterns, and/or defining or otherwise indicative of the one or more control watermarks to be inserted, as well as the generated alteration pattern, to display device 405. At 426, display device 405 may, based at least in part on the data received at 422 and 424 from content platform 402, generate one or more control watermarks, e.g., respectively corresponding to one or more alteration patterns, for insertion into content item 100. At 428, display device 405 may apply the alteration pattern and the control watermark to the content item 100, e.g., to obtain modified content item 110 of FIG. 1.

At 430, capture device 401 (e.g., computing device 101 of FIG. 1) may capture an image of (or receive a captured image of) the content item being displayed by display device 405, such content item having been modified to include the control watermark(s) and alteration pattern(s). One or more of 432-444 may be performed to detect object boundaries in the captured image. At 432, capture device 401 may normalize the captured content, such as in a similar manner as discussed at 318 of FIG. 3.

At 434, capture device 401 may detect and decode the control watermark. In some embodiments, content platform 402 and/or display device 405 may share or communicate or provide (e.g., provide instructions for executing) the digital watermarking technique or algorithm used to apply one or more control watermark(s) (e.g., implemented at a server 107 or at computing device 105) to capture device 401, to enable detection of the one or more watermarks. At 436, capture device 401 may retrieve the alteration pattern, e.g., from content platform 402, based on metadata embedded in the detected and decoded control watermark(s). At 438, content platform 402 may transmit the alteration pattern to capture device 401. At 440, capture device 401 may process normalized content in the alteration space, and at 442, capture device 401 may detect the alteration pattern (e.g., based on the definition of the alteration pattern transmitted to capture device 401 at 438). At 444, capture device 401 may derive the object boundaries of one or more objects, based at least in part on the detected alteration pattern(s) for the respective one or more objects. 446-454 may be implemented in a similar manner as 332-342, respectively.

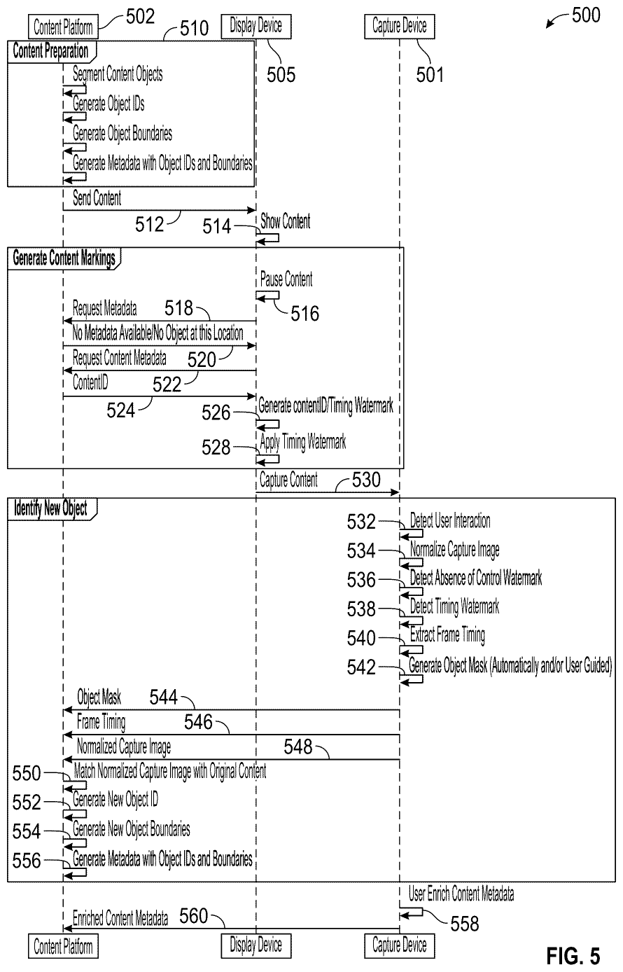

FIG. 5 shows an illustrative process 500 for extending selectable object capability to a captured image of a content item, in accordance with some embodiments of this disclosure. In the example of FIG. 5, a new object may be identified and created for metadata insertion. 510-518 may be implemented in a similar manner as 410-418, respectively. At 520, content platform 520 may provide an indication that no metadata is available and/or no object is detected at one or more locations, e.g., of the paused frame, and/or at a portion of the content item interacted with by a user at display device 505. At 522, display device 505 may request content metadata for the content item, and content platform 502 may provide a content ID for the content item (e.g., content item 110 of FIG. 1) to display device 505. At 526, display device 505 may generate or obtain the content ID, and, at 528, apply a timing watermark. In some embodiments, the timing watermark may serve as an indication that a particular portion of the content item lacks the associated metadata and/or may indicate a timestamp related to the portion of the content item. At 530, capture device 501 may capture an image of the content item being displayed by display device 505 (and as modified at 526 and/or 528).

In some embodiments, upon detection of an interaction at a capture device 501 and/or after a content capture and upon detecting that no object is associated with the interaction location by either detecting that no control watermark is present in the frame or frames at the capture device or by detecting no boundary information associated with the interaction location, the capture device may offer the user interacting with it to create a new object for future reference. For instance, when a user interaction is detected at 532 (e.g., a user taps on an unsegmented region, such as, for example, the tree depicted above the princess in content item 100 of FIG. 1), the media application may to at generate or perform a local image segmentation, or it may provide a prompt or interface for users to color, circle, or otherwise provide an indication in the region of the object the user is interested in. In some embodiments, at 534, capture device 501 may normalize the capture image, and, at 536, detect the absence of a control watermark. At 538, capture device 501 may detect the timing watermark, and extract a frame timing from the timing watermark, at 540. At 542, the capture device may generate an object mask (automatically and/or user-guided) at a portion of captured image of the content item associated with the detected user interaction.

At 544-548, the media application may send the captured image and the bounding mask, as well as a time stamp (e.g., to provide an indication to content platform 502 of where to look for similar portions of the picture in a complete unaltered video program or other content item), to content platform 502. This step transfers back to the content platform server (e.g., server 107 of FIG. 1) the information in the frame of reference of the capture device in a way that is understandable by the content platform 502. To enable that, a content server of content platform 502 and/or the display device 505 may include time information and content identification in the timing watermark (e.g., another control watermark), allowing a capture device 501 to extract a relative time tag for the image/video segment it captured as well as a content identifier. With that information, the capture device may now communicate with the content server and request the creation of a new object with the associated timestamp, captured image and selection mask. The content server may then, at 550, attempt to match the captured image with the unaltered content at or around the timestamp sent by the capture device 501. Upon detecting a match, the content server may then, at 552-556, convert the object mask sent by the capture device into the frame of reference of the unaltered content, and create a new object, including generating a new object ID and new object boundaries, as well as metadata with such object IDs and boundaries.

In some embodiments, a user of capture device 501 may be prompted at 558 to enrich the metadata for the newly added object in the captured image of the content item, and such enriched metadata may be provided, at 560, to content platform 502, to enable the enriched metadata to be stored and provided for subsequent instances of accessing supplemental information associated with content item 110, e.g., by way of captured images of content item 110. The user may be permitted to enrich the content metadata, e.g., by manually selecting and annotating, on the capture device 501, a portion of an image. In some embodiments, content platform 502 may place the newly identified object in a tentative state until other users also identify it. Once it reaches a certain threshold (e.g., a certain number of users), it may become permanently available for all users, and the metadata input by all the users may be appended.

In some embodiments, at 554, content platform 502 may generate an alteration pattern to be applied within the boundaries of the new object. In some embodiments, at least a portion of the processing to generate such alteration pattern may be performed by a client device, e.g., capture device 501 of FIG. 5, such as, for example, if capture device 501 has obtained a screenshot or captured image of the entirety of a content item of substantial portion thereof and/or if the content item is not currently associated with any alteration patterns. For example, the client device may transmit the further altered image (e.g., with the inserted alteration pattern for the new object) back to content platform 502, update the control watermark(s) to include a reference to such new alteration pattern, and/or update the data referenced by a URL in the control watermark, or otherwise request the server to perform such actions. In some embodiments, a server (e.g., server 107), upon receiving such data from capture device 501, may verify that the newly inserted alteration patterns do not interfere with existing alteration patterns in the image, and/or may modify processing performed by capture device 501 to address such interferences.

The techniques described herein may be used to identify an object within a portion of a program, a portion of which it has captured, based on invisible watermarks inserted by either the content server or the playback device and detectable by the capture device, leveraging the scalability of crowdsourced metadata. For example, viewers can contribute their unique insights, creating a rich and diverse pool of metadata that may be difficult to generate through automated systems or professional curators alone. Crowdsourced metadata can capture niche perspectives, such as fans providing expert knowledge on character development, plot theories, or cultural references in ways that algorithms might miss. Crowdsourced metadata can also provide real-time feedback on content, with users adding tags, correcting errors, or contributing additional information as they watch. This continuous feedback loop allows for evolving metadata that stays relevant as new cultural trends, fan theories, or actor developments emerge. For example, fans might highlight Easter eggs or hidden references in a scene, which might not be apparent to a general audience. Allowing users to contribute metadata fosters deeper community engagement, creating a sense of ownership over content. Platforms could personalize recommendations based on metadata added by similar audiences or specific communities. A passionate fan base might contribute detailed information about a show's lore, helping fellow fans discover scenes, characters, or even similar shows they may enjoy. The disclosed techniques provide a convenient and efficient mechanism for viewers to contribute metadata to a show and to content providers to indicate the need for metadata.

FIGS. 6-7 depict illustrative devices, systems, servers, and related hardware for extending selectable object capability to a captured image, in accordance with some embodiments of the present disclosure. In some embodiments, any suitable combination of the components of FIGS. 6-7 may be employed to perform the techniques described in FIGS. 1-5.

FIG. 6 shows generalized embodiments of illustrative computing devices 600 and 601, which may correspond to, e.g., computing device 101 and 105 of FIG. 1. For example, computing device 600 may be a smartphone device, a tablet, a near-eye display device, an XR device, or any other suitable device capable of processing images and extracting watermarked data, e.g., locally or over a communication network. In another example, computing device 601 may be a user television equipment system or device. Computing device 601 may include set-top box 616. Set-top box 616 may be communicatively connected to microphone 617, audio output equipment (e.g., speaker or headphones 614), and display 612. In some embodiments, microphone 617 may receive audio corresponding to a voice of a video conference participant and/or ambient audio data during a video conference. In some embodiments, display 612 may be a television display or a computer display or a digital billboard or any other suitable display or any combination thereof. In some embodiments, set-top box 616 may be communicatively connected to user input interface 610. In some embodiments, user input interface 610 may be a remote-control device. Set-top box 616 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of computing devices are discussed below in connection with FIG. 7. In some embodiments, device 600 may comprise any suitable number of sensors (e.g., gyroscope or gyrometer, or accelerometer, etc.), and/or a GPS module (e.g., in communication with one or more servers and/or cell towers and/or satellites) to ascertain a location of device 600. In some embodiments, device 600 comprises a rechargeable battery that is configured to provide power to the components of the device.

Each one of computing device 600 and computing device 601 may receive content and data via input/output (I/O) path 602. I/O path 602 may provide content (e.g., broadcast programming, on-demand programming, internet content, content available over a local area network (LAN) or wide area network (WAN), and/or other content) and data to control circuitry 604, which may comprise processing circuitry 607 and storage 608. Control circuitry 604 may be used to send and receive commands, requests, and other suitable data using I/O path 602, which may comprise I/O circuitry. I/O path 602 may connect control circuitry 604 (and specifically processing circuitry 607) to one or more communications paths (described below). I/O functions may be provided by one or more of these communications paths, but are shown as a single path in FIG. 6 to avoid overcomplicating the drawing. While set-top box 616 is shown in FIG. 6 for illustration, any suitable computing device having processing circuitry, control circuitry, and storage may be used in accordance with the present disclosure. For example, set-top box 616 may be replaced by, or complemented by, a personal computer (e.g., a notebook, a laptop, a desktop), a smartphone (e.g., device 600), an XR device, a tablet, a network-based server hosting a user-accessible client device, a non-user-owned device, any other suitable device, or any combination thereof.

Control circuitry 604 may be based on any suitable control circuitry such as processing circuitry 607. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 604 executes instructions for the media application stored in memory (e.g., storage 608). Specifically, control circuitry 604 may be instructed by the media application to perform the functions discussed above and below. In some implementations, processing or actions performed by control circuitry 604 may be based on instructions received from the media application.

In client/server-based embodiments, control circuitry 604 may include communications circuitry suitable for communicating with a server or other networks or servers. The media application may be a stand-alone application implemented on a device or a server. The media application may be implemented as software or a set of executable instructions. The instructions for performing any of the embodiments discussed herein of the media application may be encoded on non-transitory computer-readable media (e.g., a hard drive, random-access memory on a DRAM integrated circuit, read-only memory on a BLU-RAY disk, etc.). For example, in FIG. 6, the instructions may be stored in storage 608, and executed by control circuitry 604 of a device 600.

In some embodiments, the media application may be a client/server application where only the client application resides on device 600, and a server application resides on an external server (e.g., server 704 and/or media content source 702). In some embodiments, media content source 702 and/or server 704 corresponds to server(s) 106 of FIG. 1. For example, the media application may be implemented partially as a client application on control circuitry 604 of device 600 and partially on server 704 as a server application running on control circuitry 711. Server 704 may be a part of a local area network with one or more of devices 600, 601 or may be part of a cloud computing environment accessed via the internet. In a cloud computing environment, various types of computing services for performing searches on the internet or informational databases, providing video communication capabilities, providing storage (e.g., for a database) or parsing data are provided by a collection of network-accessible computing and storage resources (e.g., server 704 and/or an edge computing device), referred to as “the cloud.” Device 600 may be a cloud client that relies on the cloud computing capabilities from server 704 to generate and/or extract watermarked data. The client application may instruct control circuitry 604 to generate personalized engagement options in a VR environment.

Control circuitry 604 may include communications circuitry suitable for communicating with a server, edge computing systems and devices, a table or database server, or other networks or servers. The instructions for carrying out the above mentioned functionality may be stored on a server (which is described in more detail in connection with FIG. 7). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the internet or any other suitable communication networks or paths (which is described in more detail in connection with FIG. 7). In addition, communications circuitry may include circuitry that enables peer-to-peer communication of user equipment, or communication of computing device in locations remote from each other (described in more detail below).

Memory may be an electronic storage device provided as storage 608 that is part of control circuitry 604. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 608 may be used to store various types of content described herein as well as media application data described above. Nonvolatile memory may also be used (e.g., to launch a boot-up routine and other instructions). Cloud-based storage, described in relation to FIG. 6, may be used to supplement storage 608 or instead of storage 608.

Control circuitry 604 may include video generating circuitry and tuning circuitry, such as one or more analog tuners, one or more MPEG-2 decoders or MPEG-2 decoders or decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 604 may also include scaler circuitry for upconverting and downconverting content into the preferred output format of computing device 600. Control circuitry 604 may also include digital-to-analog converter circuitry and analog-to-digital converter circuitry for converting between digital and analog signals. The tuning and encoding circuitry may be used by computing device 600, 601 to receive and to display, to play, or to record content. The tuning and encoding circuitry may also be used to receive video communication session data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 608 is provided as a separate device from computing device 600, the tuning and encoding circuitry (including multiple tuners) may be associated with storage 608.

Control circuitry 604 may receive instruction from a user by way of user input interface 610. User input interface 610 may be any suitable user interface, such as a remote control, mouse, trackball, keypad, keyboard, touchscreen, touchpad, stylus input, joystick, voice recognition interface, or other user input interfaces. Display 612 may be provided as a stand-alone device or integrated with other elements of each one of computing device 600 and computing device 601. For example, display 612 may be a touchscreen or touch-sensitive display. In such circumstances, user input interface 610 may be integrated with or combined with display 612. In some embodiments, user input interface 610 includes a remote-control device having one or more microphones, buttons, keypads, any other components configured to receive user input or combinations thereof. For example, user input interface 610 may include a handheld remote-control device having an alphanumeric keypad and option buttons. In a further example, user input interface 610 may include a handheld remote-control device having a microphone and control circuitry configured to receive and identify voice commands and transmit information to set-top box 616.

Audio output equipment 614 may be integrated with or combined with display 612. Display 612 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 612. Audio output equipment 614 may be provided as integrated with other elements of each one of device 600 and device 601 or may be stand-alone units. An audio component of videos and other content displayed on display 612 may be played through speakers (or headphones) of audio output equipment 614. In some embodiments, audio may be distributed to a receiver (not shown), which processes and outputs the audio via speakers of audio output equipment 614. In some embodiments, for example, control circuitry 604 is configured to provide audio cues to a user, or other audio feedback to a user, using speakers of audio output equipment 614. There may be a separate microphone 617 or audio output equipment 614 may include a microphone configured to receive audio input such as voice commands or speech. For example, a user may speak letters or words that are received by the microphone and converted to text by control circuitry 604. In a further example, a user may voice commands that are received by a microphone and recognized by control circuitry 604. Camera 618 may be any suitable video camera integrated with the equipment or externally connected. Camera 618 may be a digital camera comprising a charge-coupled device (CCD) and/or a complementary metal-oxide semiconductor (CMOS) image sensor. Camera 618 may be an analog camera that converts to digital images via a video card.

The media application may be implemented using any suitable architecture. For example, it may be a stand-alone application wholly implemented on each one of computing device 600 and computing device 601. In such an approach, instructions of the application may be stored locally (e.g., in storage 608), and data for use by the application is downloaded on a periodic basis (e.g., from an out-of-band feed, from an internet resource, or using another suitable approach). Control circuitry 604 may retrieve instructions of the application from storage 608 and process the instructions to provide video conferencing functionality and generate any of the displays discussed herein. Based on the processed instructions, control circuitry 604 may determine what action to perform when input is received from user input interface 610. For example, movement of a cursor on a display up/down may be indicated by the processed instructions when user input interface 610 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 604 may allow a user to provide user profile information or may automatically compile user profile information. For example, control circuitry 604 may access and monitor network data, video data, audio data, processing data, participation data from a conference participant profile. Control circuitry 604 may obtain all or part of other user profiles that are related to a particular user (e.g., via social media networks), and/or obtain information about the user from other sources that control circuitry 604 may access. As a result, a user can be provided with a unified experience across the user's different devices.

In some embodiments, the media application is a client/server-based application. Data for use by a thick or thin client implemented on each one of computing device 600 and computing device 601 may be retrieved on-demand by issuing requests to a server remote to each one of computing device 600 and computing device 601. For example, the remote server may store the instructions for the application in a storage device. The remote server may process the stored instructions using circuitry (e.g., control circuitry 604) and generate the displays discussed above and below. The client device may receive the displays generated by the remote server and may display the content of the displays locally on device 600. This way, the processing of the instructions is performed remotely by the server while the resulting displays (e.g., that may include text, a keyboard, or other visuals) are provided locally on device 600. Device 600 may receive inputs from the user via input interface 610 and transmit those inputs to the remote server for processing and generating the corresponding displays. For example, device 600 may transmit a communication to the remote server indicating that an up/down button was selected via input interface 610. The remote server may process instructions in accordance with that input and generate a display of the application corresponding to the input (e.g., a display that moves a cursor up/down). The generated display is then transmitted to device 600 for presentation to the user.

In some embodiments, the media application may be downloaded and interpreted or otherwise run by an interpreter or virtual machine (run by control circuitry 604). In some embodiments, the media application may be encoded in the ETV Binary Interchange Format (EBIF), received by control circuitry 604 as part of a suitable feed, and interpreted by a user agent running on control circuitry 604. For example, the media application may be an EBIF application. In some embodiments, the media application may be defined by a series of JAVA-based files that are received and run by a local virtual machine or other suitable middleware executed by control circuitry 604. In some of such embodiments (e.g., those employing MPEG-2, MPEG-4, HEVC or any other suitable digital media encoding schemes), the media application may be, for example, encoded and transmitted in an MPEG-2 object carousel with the MPEG audio and video packets of a program.

As shown in FIG. 7, computing device 706, 707, 708, 710 (which may correspond to, e.g., e.g., computing device 101 and 105 of FIG.; display device 405 of FIG. 4) may be coupled to communication network 709. Communication network 709 may be one or more networks including the internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 709) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 7 to avoid overcomplicating the drawing.

Although communications paths are not drawn between user equipment, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The computing device may also communicate with each other directly through an indirect path via communication network 709.

System 700 may comprise media content source 702, one or more servers 704, and/or one or more edge computing devices. In some embodiments, the media application may be executed at one or more of control circuitry 711 of server 704 (and/or control circuitry of computing device 706, 707, 708, 710 and/or control circuitry of one or more edge computing devices). In some embodiments, the media content source and/or server 704 may be configured to host or otherwise facilitate video communication sessions between computing device 706, 707, 708, 710 and/or any other suitable user equipment, and/or host or otherwise be in communication (e.g., over network 709) with one or more social network services.

In some embodiments, server 704 may include control circuitry 711 and storage 714 (e.g., RAM, ROM, Hard Disk, Removable Disk, etc.). Storage 714 may store one or more databases. Server 704 may also include an I/O path 712. I/O path 412 may provide video conferencing data, device information, or other data, over a local area network (LAN) or wide area network (WAN), and/or other content and data to control circuitry 711, which may include processing circuitry, and storage 714. Control circuitry 711 may be used to send and receive commands, requests, and other suitable data using I/O path 712, which may comprise I/O circuitry. I/O path 712 may connect control circuitry 711 (and specifically control circuitry) to one or more communications paths.

Control circuitry 711 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 411 may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 711 executes instructions for an emulation system application stored in memory (e.g., the storage 714). Memory may be an electronic storage device provided as storage 414 that is part of control circuitry 711.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A computer-implemented method comprising:
capturing an image of a content item, wherein an alteration pattern is applied to a portion of the content item corresponding to an object in the content item;
detecting, in the captured image, a control watermark applied to at least one portion of the content item;
extracting, from the control watermark, embedded metadata indicative of the applied alteration pattern;
based at least in part on the embedded metadata indicative of the applied alteration pattern, identifying a boundary of a region of the captured image comprising the applied alteration pattern; and
causing a portion of the captured image within the identified boundary to be selectable to access, based at least in part on the embedded metadata of the control watermark, supplemental information related to the object.

2. The method of claim 1, wherein the capturing is performed by a first computing device while the content item is being displayed on a second computing device, and while the first computing device and the second computing device are not in communication with each other.

3. The method of claim 1, wherein a first computing device communicates with a second computing device prior to the capturing, and wherein the capturing, the detecting, and the extracting are performed by the first computing device without further communication with the second computing device.

4. The method of claim 1, wherein:
the embedded metadata indicative of the applied alteration pattern in the control watermark comprises at least one of a universal resource locator (URL) or an identifier of the object;
the at least one of the URL or the identifier of the object is used to request, over a network, data defining characteristics of the applied alteration pattern for the object; and
the data defining characteristics of the applied alteration pattern is used to identify the boundary of the region of the captured image comprising the applied alteration pattern.

5. The method of claim 1, further comprising:
receiving selection of the portion of the captured image at the computing device;
providing a prompt to add supplemental content for the object;
receiving input at the computing device of the added supplemental content; and
transmitting the added supplemental content added to a server, wherein the server updates the embedded metadata based at least in part on the added supplemental content.

6. The method of claim 1, wherein the applied control watermark and the applied alteration pattern are not perceptible to the human eye, and wherein the applied alteration pattern is a watermark.

7. The method of claim 1, wherein the portion of the captured image within the identified boundary is a first portion, the object is a first object, the method further comprising:
receiving input in relation to a second portion of the captured image;
determining that an alteration pattern is not associated with the second portion of the captured image; and
providing a prompt to specify a second object that is present at the second portion of the captured image; and
transmitting a reply to the prompt to a remote server, wherein the remote server applies an alteration pattern to a portion of the image corresponding to the second object.

8. (canceled)

9. The method of claim 1, wherein the captured image is of a frame of a plurality of frames of a video, and wherein the alteration pattern is applied to the portion of the video corresponding to the object by alternating between applying the alteration pattern to a first frame, and not applying the alteration pattern to a second frame, the method further comprising:
identifying the boundary of the region based at least in part by comparing the first frame to the second frame.

10. A computer-implemented method comprising:
for a given content item, modifying the content item by:
identifying one or more objects in the content item;
applying an alteration pattern to a portion of the content item corresponding to an object of the one or more objects in the content item;
applying a control watermark to at least one portion of the content item, wherein the control watermark embeds metadata indicative of the applied alteration pattern; and
causing, based at least in part on a request, and based at least in part on the applied alteration pattern and the applied control watermark, supplemental information related to the object to be provided to a computing device.

11. The method of claim 10, wherein the modifying of the content item enables the computing device to:
detect the control watermark in a captured image of the modified content item;
extract, from the control watermark, the embedded metadata indicative of the applied alteration pattern;
based at least in part on the embedded metadata indicative of the applied alteration pattern, identify a boundary of a region of the captured image comprising the alteration pattern; and
cause a portion of the captured image within the identified boundary to be selectable to access, based at least in part on the embedded metadata of the control watermark, the supplemental information related to the object.

12. The method of claim 10, wherein the computing device is a first computing device, the method further comprising:
receiving an indication of a selection at the first computing device of a portion of a first image, wherein the selected portion of the first image corresponds to the object of the content item;
causing the first computing device to display a prompt to add supplemental content for the object;
receiving, from the computing device, an indication of the added supplemental content;
updating the embedded metadata based at least in part on the added supplemental content;
receiving an indication of a selection at a second computing device of a portion of a second image, wherein the selected portion of the second image corresponds to the object of the content item; and
causing the added supplemental content to be provided to the second computing device.

13. The method of claim 10, wherein applying the alteration pattern to the portion of the content item corresponding to the object comprises:
identifying a plurality of pixels included in the portion of the content item corresponding to the object; and
modifying a brightness level of at least a subset of the plurality of pixels.

14. The method of claim 10, wherein the content item is a video comprising a plurality of frames, and applying the alteration pattern to the portion of the content item corresponding to the object further comprises:
alternating between applying the alteration pattern to a first frame of the video, and not applying the alteration pattern to a second frame of the video.

15. The method of claim 10, wherein the content item is a video comprising a plurality of frames of a video, the portion is a first portion of a first frame, and applying the alteration pattern further comprises:
identifying a second portion of a second frame of the plurality of frames at which the object is present;
for the first frame, applying the alteration pattern to the first portion, and to a portion of the first frame corresponding to a location of the object in the second portion; and
for the second frame, applying the alteration pattern to the second portion, and to a portion of the second frame corresponding to a location of the object in the first portion.

16. The method of claim 10, wherein the control watermark is embedded at a portion of the content item that is proximate to, but does not overlap with, the portion of the content item at which the alteration pattern is applied.

17. The method of claim 10, wherein the control watermark is embedded at a portion of the content item that overlaps with the portion of the content item at which the alteration pattern is applied.

18. The method of claim 10, wherein the embedded metadata in the control watermark comprises at least one of a universal resource locator (URL) or an identifier of the object, and the at least one of the URL or the identifier of the object is used to request, over a network, the indication of the applied alteration pattern for the object.

19. The method of claim 10, wherein the object is included in a plurality of objects of the content item, the method further comprising:
applying a plurality of alteration patterns to the plurality of objects, respectively, wherein the control watermark comprises metadata indicative of each of the plurality of objects and of each respective alternation pattern.

20. The method of claim 10, wherein the object is included in a plurality of objects of the content item, the method further comprising:
applying a plurality of alteration patterns to a plurality of portions of the content item, respectively, wherein the plurality of portions of the content item respectively correspond to the plurality of objects; and
applying a plurality of control watermarks to the content item, wherein each respective control watermark of the plurality of control watermarks comprises embedded metadata indicative of a particular object of the plurality of objects and an alteration pattern of the plurality of alteration patterns that corresponds to the particular object.

21. A system comprising:
control circuitry configured to:
capture an image of a content item, wherein an alteration pattern is applied to a portion of the content item corresponding to an object in the content item;
detect, in the captured image, a control watermark applied to at least one portion of the content item;
extracting, from the control watermark, embedded metadata indicative of the applied alteration pattern;
based at least in part on the embedded metadata indicative of the applied alteration pattern, identifying a boundary of a region of the captured image comprising the applied alteration pattern; and
cause a portion of the captured image within the identified boundary to be selectable to access, based at least in part on the embedded metadata of the control watermark, supplemental information related to the object.

22.-100. (canceled)
